(19) United States
(12) Patent Application Publication
(10) Pub. No.: US 2024/0230823 A9
(43) Pub. Date: Jul. 11, 2024

(54) METHOD, APPARATUS AND SYSTEM FOR PERFORMING POSITION LOCATION USING CELLULAR SIGNALS

(71) Applicant: Focal Point Positioning Limited, Cambridge (GB)

(72) Inventors: Ramsey Michael FARAGHER, Cambridge (GB); Robert Mark Crockett, Cambridge (GB); Peter James Duffett-Smith, Cambridge (GB)

(21) Appl. No.: 18/381,071

(22) Filed: Oct. 17, 2023

Related U.S. Application Data
(60) Provisional application No. 63/418,064, filed on Oct. 21, 2022.

(51) Int. Cl. G01S 5/02; G01S 5/10

(52) U.S. Cl. CPC G01S 5/021; G01S 5/10; G01S 2205/008

(57) ABSTRACT

A method, apparatus and system for determining a location of a receiver using cellular signals include determining a motion of a respective antenna of at least one receiver that received at least one cellular signal, using the determined antenna motion, performing motion compensated correlation on the received at least one cellular signal to generate at least one motion compensated correlation result, determining a direction of arrival for the received at least one cellular signal using the at least one motion compensated correlation result, and determining a location of the at least one receiver using the determined direction of arrival of the received at least one cellular signal and location information related to the at least one emitter from which the at least one cellular signal was received.

### CROSS-REFERENCE TO RELATED APPLICATIONS

This application claims benefit of U.S. Provisional Patent Application Ser. No. 63/418,064 filed Oct. 21, 2022, which is herein incorporated by reference in its entirety.

### BACKGROUND

### Field

Embodiments of the present principles generally relate to radio communications and, in particular, to a method, apparatus, and system for performing position location using cellular signals.

### Description of the Related Art

Cellular telephone networks are designed as a network of interconnected cells where each cell has a centrally located tower or other structure supporting antennas for an emitter, such as a cellular base station, that communicate with mobile transceivers operating in a 0.1 to 10 km radius. In many instances, the antennas have stationary positions upon tall buildings, water towers, telephone poles, light poles or any structure with substantial height to form a cellular mast.

Cellular signal transceivers (handsets) send and receive signals to/from cellular base stations to facilitate data and voice communications between handsets. In some instances, the cellular transceiver may be used to estimate the position of the handset. Typically, such positioning requires a transceiver with multiple antennas and reception of signals from at least three base stations that are received in a low multipath environment, e.g., open space without buildings or other objects proximate the transceiver. The transceiver also requires knowledge of the location of the cellular base station antennas. In such a situation, the transceiver receives the cellular signals and can use code phase or carrier phase computations to compute the transceiver's location relative to the base station antenna locations.

Unfortunately, most handsets have a single antenna and most environments where handsets are used experience a substantial amount of multipath interference. In these situations, a handset cannot determine its position in an accurate way using cellular signals.

Sometimes it is possible to determine an accurate position using other radio signals such as GNSS signals. However, these signals may not always be available, especially if the receiver is in a challenging positioning environment, such as indoors.

Therefore, there is a need for a method and apparatus for performing more accurate position location of receivers using cellular signals.

### SUMMARY

Embodiments of the present principles generally relate to a method, apparatus, and system for performing position location of receivers using cellular signals as shown in and/or described in connection with at least the figures.

In accordance with the present principles, a location of the receiver can be determined based only on direction of arrival information for cellular signals. According to this technique it is possible to determine an accurate position even if one or more of the received signals has been reflected from potentially unknown surfaces. Equally, it is possible to determine a position even the location of the emitters is not known accurately or if signals are received from only one emitter. This can advantageously improve a receiver's knowledge of position in an urban environment in the absence of conventional positioning signals, such as GNSS signals.

The step of determining the location of the receiver can also be based on calculated ranges or determined path lengths for the received signals transmitted from the at least one cellular signal base station transceiver (emitter). Ranges or path lengths may be calculated using time of arrival (TOA), time difference of arrival (TDOA) or other known techniques for cellular signals.

These and other features and advantages of the present principles can be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present principles can be understood in detail, a particular description of the present principles, may be had by reference to embodiments, some of which are illustrated in the appended drawings. It is to be noted, however, that the appended drawings illustrate only typical embodiments of the present principles and are therefore not to be considered limiting of its scope, for the present principles may admit to other equally effective embodiments.

FIG. 1 depicts a high-level block diagram of a communication environment in which a receiver of the present principles can be implemented in accordance with at least one embodiment of the present principles;

FIG. 2 depicts a high-level block diagram of a receiver in accordance with at least one embodiment of the present principles;

FIG. 3 depicts a functional diagram of a receiver of the present principles, such as the receiver of FIGS. 1 and 2, in accordance with at least one embodiment of the present principles;

FIG. 4 depicts a flow diagram of a method for receiving and processing cellular signals in accordance with at least one embodiment of the present principles; and

FIG. 5 depicts a flow diagram of a method for performing position location in accordance with at least one embodiment of the present principles.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles provide methods, apparatuses, and systems for performing position location using cellular signals. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims.

Cellular telephone systems utilize digital signals to improve communication throughput and security. Most of these systems utilize some form of deterministic digital code to facilitate signal acquisition, e.g., Gold codes, training sequences, synchronization words, or channel characterization sequences. Such a digital code is deterministic by the receiver and repeatedly broadcast by the transmitter to enable communications receivers to acquire and receive the transmitted signals. Using such deterministic codes combined with an accurate motion model of the receiver, embodiments of the invention are useful for identifying a direction of arrival (DoA) for a propagation path between the receiver and transmitter. The technique for performing this DoA determination using receiver motion information is known as SUPERCORRELATION™ and is described in commonly assigned U.S. Pat. No. 9,780,829, issued 3 Oct. 2017; U.S. Pat. No. 10,321,430, issued 11 Jun. 2019; U.S. Pat. No. 10,816,672, issued 27 Oct. 2020; US patent publication 2020/0264317, published 20 Aug. 2020; and US patent publication 2020/0319347, published 8 Oct. 2020, which are hereby incorporated herein by reference in their entireties. From the known location of the cellular signal transmitters, a receiver can use this DoA data to compute the location of the receiver.

Using such techniques described above, a receiver can be transported through an area containing cellular emitters and can be able to compute its position from the cellular signals even when the receiver has a single antenna and/or in a multipath environment. For example, in some embodiments a receiver of the present principles can be carried by pedestrians and can be made functional via application software to perform position location. Alternatively, position location can be performed by moving the receiver using a vehicle on a ground path. In other embodiments, the receiver can be carried by an airborne vehicle—manned or unmanned (e.g., drones, helicopters, airplanes, etc.).

As the receiver traverses an area, the receiver collects DoA data for the cellular emitters that are nearby (i.e., within range of the emitter). The distance to the emitter varies depending upon the cellular standard used by the emitter. For example, a 3G based emitter may be received up to 50 km from an emitter, while a 5G based emitter may be received only 100 m from the emitter. The receiver may not know its position or may have an estimate of its position from a global navigation satellite system (GNSS) receiver and/or an inertial guidance system. In some embodiments, the receiver can maintain a database of cellular emitter locations. From the emitter position and a plurality of DoA vectors (representing direction from receiver to emitter) to a particular emitter, embodiments of the present principles can compute the location of the receiver relative to the cellular emitter. The relative location can then be translated to a geocoordinate. The receiver position determined from cellular signals in accordance with embodiments of the present principles can be used to augment the accuracy of a GNSS receiver position or inertial guidance system position. Such position assistance is especially useful in environments having substantial multipaths, such as, urban canyons where the environment contains buildings and other signal reflective objects.

In some embodiments, multiple receivers can be used to receive signals in a coordinated manner. In further embodiments, the receiver(s) can receive signals from multiple types of emitters operating in various frequency bands to facilitate gathering information related to many systems to generate a signal profile for a given area. Some embodiments can perform the signal processing locally on the moving platform. In other embodiments, the emitter information, receiver motion information and receiver location information can be gathered at the moving platform and communicated (wired or wirelessly) to a server for remote processing in real-time or at a later time.

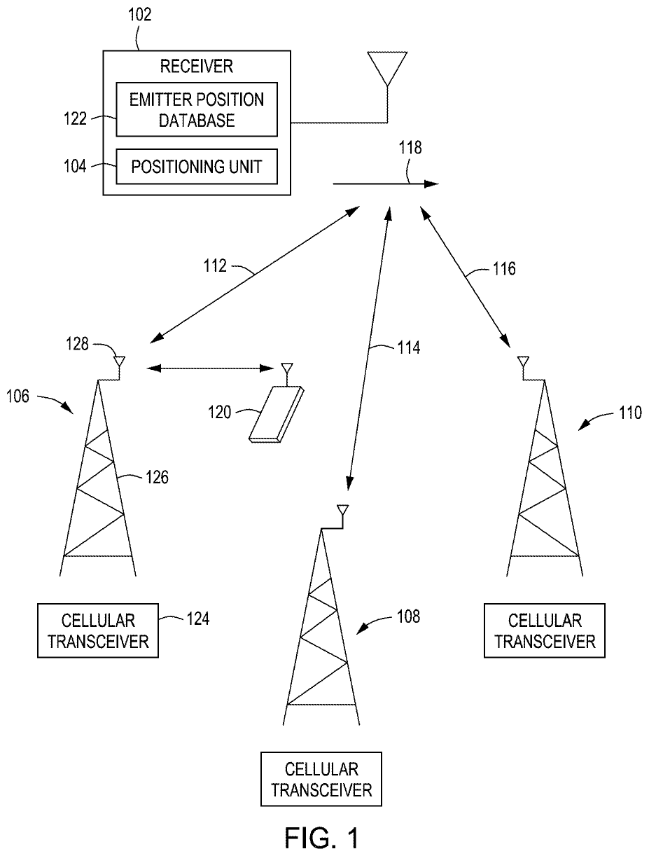

FIG. 1 depicts a high-level block diagram of a communication environment 100 in which a receiver of the present principles can be implemented in accordance with at least one embodiment of the present principles. In the communication environment 100 of FIG. 1, an emitter comprises a cellular transceiver 124, a mast 126, and an antenna 128 operating together as a conventional, fixed location cellular base station. The receiver 102 of the system 100 of FIG. 1 illustratively comprises a positioning unit 104 configured to receive and process signals transmitted by cellular emitters 106, 108, 110 (three emitters are depicted, but the receiver 102 can process the signals from any number of emitters). In some embodiments, the signals from the emitters 106, 108 and 110 are intended to communicate with a standard cellular mobile device 120 (e.g., cellular telephone, laptop computer, tablets, Internet of Things (IoT) devices, etc.) that communicate using cellular signals, e.g., CDMA, GSM and the like that support cellular standards such as, but not limited to, 3G, 4G, LTE, and/or 5G standards. In some embodiments, the receiver 102 can comprise a portion of a cellular mobile device, such as device 120, or can be a standalone positioning receiver operating in accordance with at least one embodiment of the present principles to determine its position using received cellular signals.

In the embodiment of FIG. 1, the receiver 102 comprises an emitter position database 122 and a positioning unit 104 operating to accurately locate the receiver 102 based upon reception of signals 112, 114 and 116 transmitted from emitters 106, 108, 110 in accordance with at least one embodiment of the present principles. As described in detail below, the positioning unit 104 uses a SUPERCORRELATION™ technique as described in commonly assigned U.S. Pat. No. 9,780,829, issued 3 Oct. 2017; U.S. Pat. No. 10,321,430, issued 11 Jun. 2019; U.S. Pat. No. 10,816,672, issued 27 Oct. 2020; US patent publication 2020/0264317, published 20 Aug. 2020; and US patent publication 2020/0319347, published 8 Oct. 2020, which are hereby incorporated herein by reference in their entireties.

The technique described herein determines a direction of arrival (DoA) of received signals 112, 114, 116. For example, in some embodiments as the receiver 102 moves (represented by arrow 118), the positioning unit 104 computes motion information representing motion of the receiver 102. The motion information is used to perform motion compensated correlation of the received signals 112, 114, 116. In some embodiments, motion compensated correlation can be performed on cellular signals received from a plurality of cellular signal base stations (emitters). In this way, the determined location of the receiver can be based on cellular signals from multiple base stations. This technique can be most suitable when the receiver is able to communicate with base stations having a longer range. In some embodiments, it can be possible to determine a more accurate position when signals are received from cellular signal base stations (emitters) in a spread of two-dimensional directions.

In some embodiments of the present principles, motion compensated correlation can be performed on a plurality of received signals from a single cellular base station. The plurality of received signals can include one or more reflected signals having different directions of arrival. The plurality of received signals can also include a signal that is received directly along the line-of-sight direction between the receiver and the cellular signal base station (emitter). A mixture of different signals from one or more cellular base stations (emitters) can be used, including direct signals and reflected signals.

From the motion compensated correlation process, the positioning unit 104 of the receiver 102 can estimate the DoA of the signals 112, 114, 116. The emitter database 122 can provide an accurate location for the emitters 106, 108, 110 using information that was pre-stored in the emitter database 122 regarding known locations of emitters. The positioning unit 104 uses the known emitter positions along with the DoA data determined for received cellular signals to determine a location of the receiver 102. The intersection of a plurality of DoA vectors generated as the receiver moves along path 118 identifies the location of the receiver 102 as described in further detail below. In accordance with the present principles, a location process of the present principles for locating a receiver can be performed using any kind of received cellular signal such as 3G, 4G or 5G. Additionally, more than one kind of cellular signal can be processed by the receiver in parallel in accordance with the present principles.

In addition, in some embodiments, the location of the receiver in accordance with the present principles can be performed for a plurality of time periods to determine a plurality of positions for a moving receiver.

In some embodiments, alternatively or in addition, the received cellular signals can be processed to determine time of arrival (TOA) or time difference of arrival (TDOA) information for the received signals. The TOA and TDOA information can be used for position calculations of the receivers by calculating ranges from the receiver to the emitter(s). As described further below, such calculations can be used to augment the DoA vector processing to improve the speed at which a position solution is calculated.

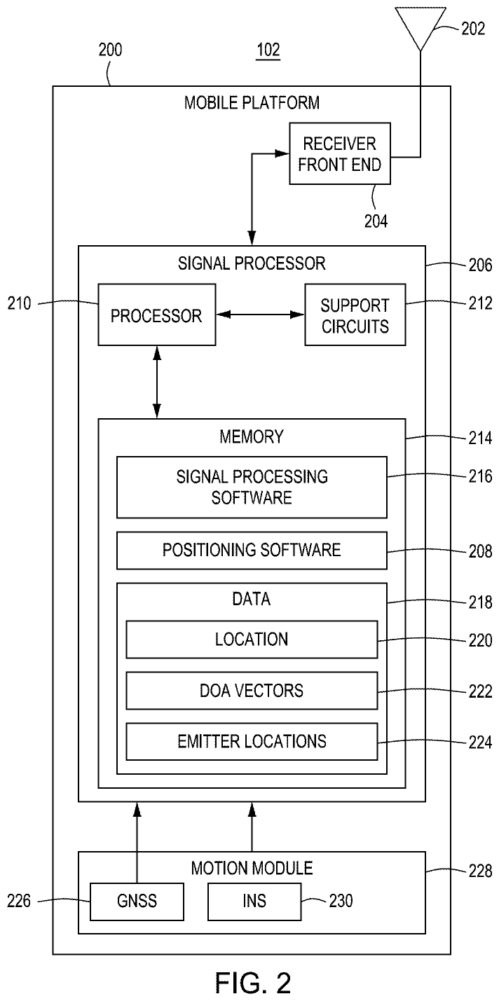

FIG. 2 depicts a high-level block diagram of a receiver in accordance with at least one embodiment of the present principles. The receiver 102 of FIG. 2 comprises a mobile platform 200, an antenna 202, a receiver front end 204, a signal processor 206, and a motion module 228. In some embodiments, the receiver 102 can comprise a portion of a laptop computer, mobile phone, tablet computer, Internet of Things (IoT) device, unmanned aerial vehicle, mobile computing system in an autonomous vehicle, human operated vehicle, and the like.

In the receiver 102 of FIG. 2, the mobile platform 200 and the antenna 202 are an indivisible unit where the antenna 202 moves with the mobile platform 200. The operation of the SUPERCORRELATION™ technique operates based upon determining the motion of the signal receiving antenna. Any mention of motion herein refers to the motion of the antenna 202. In some embodiments, the antenna 202 may be separate from the mobile platform 200. In such a situation, the motion estimate used in the motion compensated correlation process is the motion of the antenna 202. In most scenarios, the motion of the mobile platform 200 is the same as the motion of the antenna 202 and, as such, the following description will assume that the motion of the platform 200 and antenna 202 are the same.

In the embodiment of FIG. 2, the mobile platform 200 comprises a receiver front end 204, a signal processor 206 and a motion module 228. The receiver front end 204 downconverts, filters, and samples (digitizes) the received signals in a manner that is well-known to those skilled in the art. The output of the receiver front end 204 is a digital signal containing data. The data of interest is a deterministic training or acquisition code, e.g., Gold code, used by the cellular emitter to synchronize the transmission to a cellular transceiver.

The signal processor 206 of FIG. 2 illustratively comprises at least one processor 210, support circuits 212 and memory 214. The at least one processor 210 can be any form of processor or combination of processors including, but not limited to, central processing units, microprocessors, microcontrollers, field programmable gate arrays, graphics processing units, digital signal processors, and the like. The support circuits 212 can comprise well-known circuits and devices facilitating functionality of the processor(s). The support circuits 212 can comprise one or more of, or a combination of, power supplies, clock circuits, analog-to-digital converters, communications circuits, cache, displays, and/or the like.

In some embodiments, the memory 214 comprises one or more forms of non-transitory computer readable media including one or more of, or any combination of, read-only memory or random-access memory. The memory 214 stores software and data including, for example, signal processing software 216, positioning software 208 and data 218. The data 218 can include the receiver location 220, direction of arrival (DOA) vectors 222 (collectively, DoA data), emitter locations 224, and various data used to perform the SUPERCORRELATION™ processing of the present principles, such as signal estimates, correlation results, motion compensation information, motion information, motion and other parameter hypotheses, position information and the like. The signal processing software 216, when executed by the one or more processors 210, performs motion compensated correlation upon the received signals to estimate the DoA vectors for the received signals. The motion compensated correlation process is described in greater detail below. The operation of the signal processing software 216 and positioning software 208 operate as the positioning unit 104 of FIG. 1.

In the embodiment of FIG. 2, the motion module 228 generates a motion estimate for the receiver 102. The motion module 228 can comprise an inertial navigation system (INS) 230 as well as a global navigation satellite system (GNSS) receiver 226 such as GPS, GLONASS, GALILEO, BEIDOU, and the like. The INS 230 can comprise one or more of, but not limited to, a gyroscope, a magnetometer, an accelerometer, and the like. To facilitate motion compensated correlation, the motion module 228 produces motion information (sometimes referred to as a motion model) comprising at least a velocity of the antenna 202 in the direction of an emitter of interest (i.e., an estimated direction of a source of a received signal). In some embodiments, the motion information can also include estimates of platform orientation or heading including, but not limited to, pitch, roll and yaw of the platform 200/antenna 202. In some embodiments, the receiver 102 can test every direction and iteratively narrow the search to one or more directions of interest.

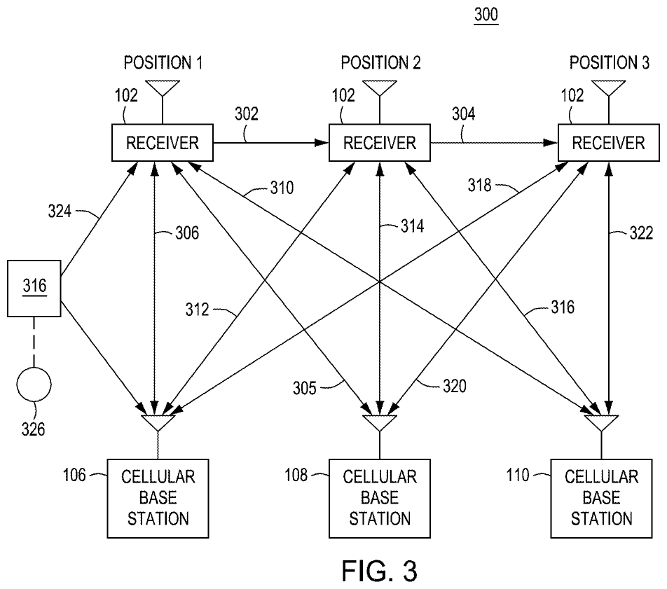

FIG. 3 depicts a functional diagram 300 of a receiver of the present principles, such as the receiver of FIGS. 1 and 2, in accordance with at least one embodiment of the present principles. The diagram 300 of FIG. 3 comprises the receiver 102 moving from position 1 along path 302 to position 2, and then moving along path 304 to position 3. As the receiver 102 traverses the area, the receiver 102 computes DoA vectors 306, 305, 310 at position 1, DoA vectors 312, 314, 316 at position 2 and DoA vectors 318, 320, 322 at position 3. The three DoA vectors 306, 305 and 310 intersect at the location of the receiver 102. Although three discrete positions are described as locations at which the DoA vectors are computed, in other embodiments, the DoA vectors can be computed periodically, intermittently or continuously as the receiver moves. Additional vectors can also be used to converge the solution onto an accurate receiver location.

In some embodiments, DOA vectors can include line-of-sight (LOS) measurements and non-line-of-sight (NLOS) measurements. For example, in an urban environment, some DoA vectors 306, 305, 310 are line-of-sight (LOS) and some DoA vectors 324 are non-line-of-sight (NLOS). The LOS vectors represent signals that are transmitted directly from the emitter 106 to the receiver 102, while NLOS vectors represent vectors that can be reflected from structures 316 in the vicinity of the receiver 102. As more and more DoA vectors are collected and processed, the LOS vectors converge on a particular location. In addition, if TOA and/or TDOA information is available, the information can be used to remove DoA vectors of NLOS paths because the arrival times will be anomalous (delayed) for the NLOS signals versus the LOS signals. That is, the time information of NLOS signals will contain a delay compared to the LOS signals.

In some embodiments of the present principles, the structures 316 of FIG. 3 can be modeled in a building model. The building model in conjunction with ray tracing techniques can be used to determine the DoA of reflected signals, based on the known position of the reflection surface 316. For example, in some embodiments of the present principles a path of a reflected emitter signal can be estimated and the reflected signals can be used in the receiver localization calculation. If a 3D model of an area is available, the receiver 102 can compute its position using the reflected signals as being sourced from virtual transmitters 326 located at the image point of the reflected signals (as shown schematically in FIG. 3). In an alternative embodiment, a plurality of reflected signals (or even a single reflected signal) and a direct signal from a single cellular base station can be used to compute the receiver position.

In other embodiments of the present principles, one or more receivers 102 can collect all emitter signals, LOS and NLOS, over a period of time while the receivers are traversing an area. These collected signals can be processed using the receiver localization techniques described herein. The signal formula will contain DoA vector intersection regions that identify receiver locations. In some embodiments, a Baysian estimator can be used to compare various hypotheses as to receiver location using information provided by available measurements.

More specifically, in embodiments involving the use of non-line-of-sight signals in spite of the indirect propagation paths, reflection model data can be obtained comprising a geometrical model of a set of structures capable of reflecting signals. Such a model, which can enable the calculation of remote source vectors based on DoAs of reflected signals which can be particularly useful in urban environments. In such embodiments, it can be beneficial to include a predetermined 3D building model, for example, that represents the structures that may obstruct and/or reflect transmissions. Using techniques such as ray tracing, propagation paths through such environments can be modelled in such a way that useful remote source vector information can be inferred even when the only signal received, for instance for a given position along a movement path of a receiver, is one that has been reflected by one or more structures. In some embodiments, the geometrical model can include a set of one or more structures, which can be natural or artificial, for example buildings, landscape, and terrain features. For example, in the vicinity of a receiver of the present principles, a model representing structures within a predetermined radius of, or within a region containing, an estimated or determined location of the receiver at a given time, can be obtained and used to model propagation paths. In some embodiments, the model data can include three-dimensional geometrical data representative of reflective structures and containing sufficient information about their position and/or orientation to enable a propagation path including one or more reflections to be determined.

In some embodiments, for NLOS signals a preferential gain can be provided for a signal received by a receiver of the present principles from a first direction in comparison with a signal received from a respective, second direction. In some embodiments, the first direction can be a line-of-sight direction between the receiver and a remote source, such as an emitter/receiver of a cell base station tower in a cellular network, while the respective second direction can be a non-line-of-sight direction. In some embodiments motion compensation is performed in such a way as to provide preferential gain for a signal received along a non-line-of-sight direction, in particular where additional information is available to enable remote source vectors to be identified from such non-line-of-sight signals.

It should be noted that in some instances, vector intersection location is not a point, but rather it is a region or area due to the probabilistic nature of the DoA vectors (i.e., the determined direction of each vector has an uncertainty caused by measurement error and the intersection forms a region rather than a point). The region can have a two-dimensional probabilistic spread with a maximum that defines the most likely location of the receiver 102.

In accordance with the present principles, since the emitters have known locations, the geolocation coordinates of the emitters can be translated into geolocation coordinates for the receiver 102. As such, a geolocation map of sequentially generated receiver locations can be produced.

In some embodiments of the present principles, such as the above-described embodiments, DoA vector and receiver location determination is performed within the receiver 102. In other embodiments, the data for producing DoA vectors, DoA vectors themselves, position information, and the like can be transmitted from the receiver to a server (not shown) for processing to determine receiver locations in accordance with the present principles.

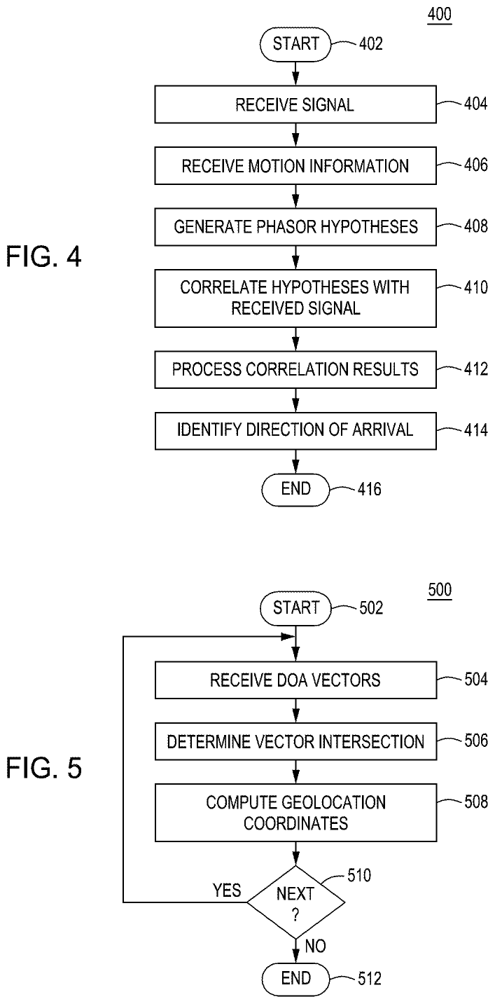

FIG. 4 depicts a flow diagram of a method 400 for receiving and processing cellular signals in accordance with at least one embodiment of the present principles. In some embodiments, the method 400 of FIG. 4 can be performed by the signal processing software 216 in accordance with at least one embodiment of the present principles. The method 400 can be implemented in software, hardware or a combination of both, for example using the signal processor 206 of FIG. 2.

The method 400 begins at 402 and proceeds to 404 where signals are received at a receiver from at least one remote source (e.g., transmitters such as the emitters 106, 108, 110 of FIG. 1) in a manner as described with respect to FIG. 1. Each received signal comprises a synchronization or acquisition code, e.g., a Gold code, extracted from the radio frequency (RF) signal received at the antenna by, in some embodiments, downconverting the RF signal and extracting the digital code. The method 400 can proceed to 406.

At 406, the method 400 receives motion information from, for example, the motion module 228 of the receiver 102 of FIG. 2. The motion information comprises an estimate of the motion of the receiver 102 (receiver antenna) of FIG. 1, including for example, one or more of velocity, heading, orientation, etc. The method 400 can proceed to 408.

At 408, the method 400 generates a plurality of phasor sequence hypotheses related to a direction of interest of the received signal (i.e., direction toward an emitter). Each phasor sequence hypothesis comprises a time series of phase offset estimates that vary with parameters such as receiver motion, frequency, DoA of the received signals, and the like. The signal processing of the present principles correlates a local code encoded in a local signal with the same code encoded within the received RF signal. In one embodiment, the phasor sequence hypotheses are used to adjust, at a sub-wavelength accuracy, the carrier phase of the local signal. In some embodiments, such adjustment or compensation can be performed by adjusting a local oscillator signal, the received signal(s), or the correlation result to produce a phase compensated correlation result. In some embodiments, the signals and/or correlation results are complex signals comprising in-phase (I) and quadrature phase (Q) components. The method applies each phase offset in the phasor sequence to a corresponding complex sample in the signals or correlation results. If the phase adjustment includes an adjustment for a component of receiver motion in an estimated direction of the emitter, then the result is a motion compensated correlation result. The method 400 can proceed to 410.

At 410, for each received signal, the method 400 correlates the received signals with a set (plurality) of direction hypotheses containing estimates of the phase offset sequences necessary to accurately correlate the received signals over a long coherent integration period (e.g., 1 second). There is a set of hypotheses representing a search space for each received signal.

That is, the motion estimates are typically hypotheses of the receiver motion in a direction of interest such as in the direction of the emitter that transmitted the received signal. At initialization, the direction of interest may be unknown or inaccurately estimated. Consequently, a brute force search technique can be used to identify one or more directions of interest by searching over all directions and correlating signals received in all directions. A comparison of correlation results over all the directions enables the method 400 to narrow the search space. There is very strong correlation between the true values of these hypotheses between code repetition, such that the initial search might be intensive, but subsequent processing only requires tracking of the parameters in the receiver as they evolve. Consequently, subsequent compensation is performed over a narrow search space.

In some embodiments of the present principles, if a signal from a given emitter was received previously, the set of hypotheses for the newly received signal include a group of phasor sequence hypotheses using the expected Doppler and Doppler rate and/or last Doppler and last Doppler rate used in receiving the prior signal from that particular emitter. The values can be centered around the last values used or the last values used additionally offset by a prediction of further offset based on the expected receiver motion. That is, at 410, the method 400 correlates each received signal with that signal's set of hypotheses. The hypotheses are used as parameters to form the phase-compensated phasors to phase compensate the correlation process. As such, the phase compensation can be applied to at least one of the received signals, the local frequency source (e.g., an oscillator), or the correlation result values. In addition to searching over the DoA, the method 400 can also apply hypotheses related to other variables (parameters) such as oscillator frequency to correct frequency and/or phase drift (if not previously corrected), or heading to ensure the correct motion compensation is being applied. The number of hypotheses may not be the same for each variable. For example, the search space can contain ten hypotheses for searching DoA and have two hypotheses for searching a receiver motion parameter such as velocity—i.e. a total of twenty hypotheses (ten multiplied by two). The result of the correlation process is a plurality of phase-compensated correlation results—one phase-compensated correlation result value for each hypothesis for each received signal. The method 400 can proceed to 412.

At 412, the method 400 processes the correlation results to find the “best” or optimal result for each received signal. In some embodiments, the correlation output can be a single value that represents the parameter hypotheses (preferred hypotheses) that provides an optimal or best correlation output. In some embodiments, a cost function is applied to the correlation values for each received signal to find the optimal correlation output corresponding to a preferred hypothesis or hypotheses (e.g., a maximum correlation value is associated with the preferred hypothesis for the correct signal DoA). The method can proceed to 414.

At 414, a direction of arrival (DOA) for the at least one signal from the at least one emitter is determined using the generated phase-compensated correlation result. That is, in some embodiments the method 400 identifies the DoA vector of each received signal from the optimal correlation result for the signal. The received signals along the DoA vector typically have the strongest signal to noise ratio and represent line of sight (LOS) reception between the transmitting emitter and the receiver 102. As such, using motion compensated correlation enables the receiver 102 to identify the DoA vector of the received signal(s). The method 400 can end at 416.

In some embodiments, rather than using the largest magnitude correlation value, other test criteria can be used. For example, alternatively or in addition, in some embodiments the method 400 can monitor the progression of correlations as hypotheses are tested and apply a cost function that indicates the best hypotheses when the cost function reaches a minimum (e.g., a small hamming distance amongst peaks in the correlation plots). In other embodiments, additional hypotheses can be tested in addition to the DoA hypotheses to, for example, ensure the motion compensation (i.e., speed and heading) is correct.

FIG. 5 depicts a flow diagram of a method for performing position location in accordance with at least one embodiment of the present principles. In some embodiments, the method 500 of FIG. 5 can be performed by the positioning software 208 in accordance with at least one embodiment of the present principles. The method 500 can be performed locally within the receiver or can be performed remotely on a server. If performed remotely, the DoA vectors and/or data to generate the DoA vectors are transmitted from the receiver to the remote server for processing in accordance with method 500.

The method 500 begins at 502 and proceeds to 504 where the method 500 receives the DoA vectors determined in, for example, the method 400 of FIG. 4, for a plurality of emitters. The method 500 can proceed to 506.

At 506, the method 500 determines a location where the DoA vectors intersect. That is and as described above, in embodiments of the present principles, a receiver location is relative to the positions of transmitting emitters. The method steps of the method 500 can be iterative as additional DoA vectors are generated or can be calculated when a predefined number (e.g., three, five, ten, etc.) of DoA vectors have been determined. In some embodiments, the position computations of the present principles can be augmented using TOA or TDOA information. For example, the time information related to the time a signal is received at various receiver positions can be used to identify LOS signals versus NLOS signals (i.e., NLOS signals have a delayed reception time as compared to LOS signals). In some embodiments, DoA vectors associated with NLOS signals may then be removed from the vector set used to determine receiver location. In some other embodiments, TOA or TDOA information can be utilized to calculate ranges from the receiver to the emitter(s). The method 500 can proceed to 508.

At 508, the method 500 computes geolocation coordinates for the receiver location by translating the known geolocation coordinates of the emitters to the receiver location determined at 506. The geolocation for the receiver location can be further constrained based on the ranges that are calculated using TOA or TDOA information. In addition, in some embodiments other available signals, such as available GNSS signals, can be used as inputs in a positioning calculation of the present principles. The method 500 can proceed to 510.

At 510, the method 500 queries whether another set of DoA vectors for emitter signals received by the receiver at a new location are available for processing. If the query is affirmatively answered, the method 500 returns to 504 to process the additional DoA vectors. If the query is negatively answered, the method 500 can end at 512.

Although the method 400 and the method 500 are described herein as comprising separate methods, in accordance with the present principles, methods of the present principles can include portions of the method 400 and the method 500 in combination for providing methods, apparatuses, and systems for locating a receiver using cellular signals. For example, in some embodiments a method for locating at least one receiver using cellular signals includes receiving at least one cellular signal from at least one emitter at a respective antenna of the at least one receiver, determining a motion of the respective antenna of the at least one receiver that received the at least one cellular signal, using the determined antenna motion, performing motion compensated correlation on the received at least one cellular signal to generate at least one motion compensated correlation result, determining a direction of arrival for the received at least one cellular signal using the at least one motion compensated correlation result, and determining a location of the at least one receiver using the determined direction of arrival of the received at least one cellular signal and location information related to the at least one emitter from which the at least one cellular signal was received.

In some embodiments, in the method, motion compensated correlation is performed on cellular signals received from a plurality of cellular signal base stations.

In some embodiments, in the method motion compensated correlation is performed on a plurality of received signals from a single cellular base station.

In some embodiment, in the method performing motion compensated correlation includes correlating at least one local signal with the at least one cellular signal from the at least one emitter to generate at least one respective correlation result, generating a plurality of phasor sequences, where each phasor sequence represents a hypothesis comprising a sequence of signal phases related to a relative direction of motion of the antenna of the at least one receiver, compensating at least one phase of at least one of the local signal, the at least one cellular signal of the at least one emitter or the at least one correlation result, based on the generated plurality of phasor sequences, to determine at least one phase-compensated correlation result, and identifying a phasor sequence in the plurality of phasor sequences that optimizes the at least one motion compensated correlation result.

In some embodiments, in the method the location of the at least one receiver is determined for a plurality of time periods to determine a plurality of positions for the at least one receiver as it moves.

In some embodiments, in the method the determining the location of the at least one receiver is further based on determined path lengths for the received at least one cellular signal transmitted from the at least one emitter.

In some embodiments, an apparatus for locating at least one receiver using cellular signals includes at least one processor and at least one memory for storing at least one of programs and instructions. In such apparatuses, when the instructions and/or programs are executed by the at least one processor, the apparatus is caused to perform operations including receiving at least one cellular signal from at least one emitter at a respective antenna of the at least one receiver, determining a motion of the respective antenna of the at least one receiver that received the at least one cellular signal, using the determined antenna motion, performing motion compensated correlation on the received at least one cellular signal to generate at least one motion compensated correlation result, determining a direction of arrival for the received at least one cellular signal using the at least one motion compensated correlation result, and determining a location of the at least one receiver using the determined direction of arrival of the received at least one cellular signal and location information related to the at least one emitter from which the at least one cellular signal was received.

In some embodiments, a system for locating at least one receiver using cellular signals includes at least one receiver comprising a respective antenna, a motion module, at least one emitter, and an apparatus including at least one processor and at least one memory for storing at least one of programs and instructions. In such embodiments, when the programs and/or instructions are executed by the at least one processor, the apparatus is caused to perform operations including receiving at least one cellular signal from at least one emitter at a respective antenna of the at least one receiver, determining a motion of the respective antenna of the at least one receiver that received the at least one cellular signal, using the determined antenna motion, performing motion compensated correlation on the received at least one cellular signal to generate at least one motion compensated correlation result, determining a direction of arrival for the received at least one cellular signal using the at least one motion compensated correlation result, and determining a location of the at least one receiver using the determined direction of arrival of the received at least one cellular signal and location information related to the at least one emitter from which the at least one cellular signal was received.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with a computing device via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device can be transmitted to the computing device via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

Any block, step, module, or otherwise described herein may represent one or more instructions which can be stored on non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g., one or more of A, B, and/or C), unless stated otherwise, it is understood to include one or more of each element, including any one or more combinations of any number of the enumerated elements (e.g. A, AB, AC, ABC, ABB, etc.). When “and/or” is used, it should be understood that the elements may be joined in the alternative or conjunctive.

While the foregoing is directed to embodiments of the present principles, other and further embodiments of the present principles may be devised without departing from the basic scope thereof, and the scope thereof is determined by the claims that follow.

1. A method for locating at least one receiver using cellular signals, comprising:
receiving at least one cellular signal from at least one emitter at a respective antenna of the at least one receiver;
determining a motion of the respective antenna of the at least one receiver that received the at least one cellular signal;
using the determined antenna motion, performing motion compensated correlation on the received at least one cellular signal to generate at least one motion compensated correlation result;
determining a direction of arrival for the received at least one cellular signal using the at least one motion compensated correlation result; and
determining a location of the at least one receiver using the determined direction of arrival of the received at least one cellular signal and location information related to the at least one emitter from which the at least one cellular signal was received.

2. The method of claim 1, wherein motion compensated correlation is performed on cellular signals received from a plurality of cellular signal base stations.

3. The method of claim 1, wherein motion compensated correlation is performed on a plurality of received signals from a single cellular base station.

4. The method of claim 1, wherein performing motion compensated correlation comprises:
correlating at least one local signal with the at least one cellular signal from the at least one emitter to generate at least one respective correlation result;
generating a plurality of phasor sequences, where each phasor sequence represents a hypothesis comprising a sequence of signal phases related to a relative direction of motion of the antenna of the at least one receiver;
compensating at least one phase of at least one of the local signal, the at least one cellular signal of the at least one emitter or the at least one correlation result, based on the generated plurality of phasor sequences, to determine at least one phase-compensated correlation result; and
identifying a phasor sequence in the plurality of phasor sequences that optimizes the at least one motion compensated correlation result.

5. The method of claim 1, wherein the location of the at least one receiver is determined for a plurality of time periods to determine a plurality of positions for the at least one receiver as it moves.

6. The method of claim 1, wherein the determining the location of the at least one receiver is further based on determined path lengths for the received at least one cellular signal transmitted from the at least one emitter.

7. An apparatus for locating at least one receiver using cellular signals, comprising at least one processor and at least one memory for storing at least one of programs and instructions that, when executed by the at least one processor, causes the apparatus to perform operations comprising:
receiving at least one cellular signal from at least one emitter at a respective antenna of the at least one receiver;
determining a motion of the respective antenna of the at least one receiver that received the at least one cellular signal;
using the determined antenna motion, performing motion compensated correlation on the received at least one cellular signal to generate at least one motion compensated correlation result;
determining a direction of arrival for the received at least one cellular signal using the at least one motion compensated correlation result; and
determining a location of the at least one receiver using the determined direction of arrival of the received at least one cellular signal and location information related to the at least one emitter from which the at least one cellular signal was received.

8. The apparatus of claim 7, wherein the apparatus further performs motion compensated correlation on cellular signals received from a plurality of cellular signal base stations.

9. The apparatus of claim 7, wherein motion compensated correlation is performed on a plurality of received signals from a single cellular base station.

10. The apparatus of claim 7, wherein performing motion compensated correlation comprises:
correlating at least one local signal with the at least one cellular signal from the at least one emitter to generate at least one respective correlation result;
generating a plurality of phasor sequences, where each phasor sequence represents a hypothesis comprising a sequence of signal phases related to a relative direction of motion of the antenna of the at least one receiver;
compensating at least one phase of at least one of the local signal, the at least one cellular signal of the at least one emitter or the at least one correlation result, based on the generated plurality of phasor sequences, to determine at least one phase-compensated correlation result; and
identifying a phasor sequence in the plurality of phasor sequences that optimizes the at least one motion compensated correlation result.

11. The apparatus of claim 7, wherein the location of the at least one receiver is determined for a plurality of time periods to determine a plurality of positions for the at least one receiver as it moves.

12. The apparatus of claim 7, wherein the determining the location of the at least one receiver is further based on determined path lengths for the received at least one cellular signal transmitted from the at least one emitter.

13. A system for locating at least one receiver using cellular signals, comprising:
at least one receiver comprising a respective antenna;
a motion module;
at least one emitter; and
an apparatus comprising at least one processor and at least one memory for storing at least one of programs and instructions that, when executed by the at least one processor, causes the apparatus to perform operations comprising:
receiving at least one cellular signal from at least one emitter at a respective antenna of the at least one receiver;
determining a motion of the respective antenna of the at least one receiver that received the at least one cellular signal;
using the determined antenna motion, performing motion compensated correlation on the received at least one cellular signal to generate at least one motion compensated correlation result;
determining a direction of arrival for the received at least one cellular signal using the at least one motion compensated correlation result; and
determining a location of the at least one receiver using the determined direction of arrival of the received at least one cellular signal and location information related to the at least one emitter from which the at least one cellular signal was received.

14. The system of claim 13, wherein the apparatus further performs motion compensated correlation on cellular signals received from a plurality of cellular signal base stations.

15. The system of claim 13, wherein motion compensated correlation is performed on a plurality of received signals from a single cellular base station.

16. The system of claim 13, wherein performing motion compensated correlation comprises:
correlating at least one local signal with the at least one cellular signal from the at least one emitter to generate at least one respective correlation result;
generating a plurality of phasor sequences, where each phasor sequence represents a hypothesis comprising a sequence of signal phases related to a relative direction of motion of the antenna of the at least one receiver;
compensating at least one phase of at least one of the local signal, the at least one cellular signal of the at least one emitter or the at least one correlation result, based on the generated plurality of phasor sequences, to determine at least one phase-compensated correlation result; and
identifying a phasor sequence in the plurality of phasor sequences that optimizes the at least one motion compensated correlation result.

17. The system of claim 13, wherein the location of the at least one receiver is determined for a plurality of time periods to determine a plurality of positions for the at least one receiver as it moves.

18. The system of claim 13, wherein the determining the location of the at least one receiver is further based on determined path lengths for the received at least one cellular signal transmitted from the at least one emitter.
